(19) United States
(12) Patent Application Publication
(10) Pub. No.: US 2009/0166156 A1
(43) Pub. Date: Jul. 2, 2009

(54) CONVEYOR APPARATUS AND MANUFACTURING APPARATUS INCORPORATING THE SAME

(76) Inventor: Raymond Paul Baron, South Glamorgan (GB)

Correspondence Address: EDWIN D. SCHINDLER, FIVE HIRSCH AVENUE, P.O. BOX 966, CORAM, NY, 11727-0966, US

(21) Appl. No.: 12/282,094

(22) PCT Filed: Mar. 6, 2007
(86) PCT No.: PCT/GB07/50103

§ 371 Date: Dec. 15, 2008

(30) Foreign Application Priority Data
Mar. 6, 2006 (GB) 0604324.4

(51) Int. Cl. B65G 47/86

(52) U.S. Cl. 198/468.2

(57) ABSTRACT

A conveyor apparatus for conveying sheet material articles includes a conveyor belt mounted at opposite ends thereof to respective rollers and jaws attached to the conveyor belt for gripping the leading edge of the sheet material articles to be conveyed. Actuators selectively open and close the jaws at one or more rotary positions of the conveyor belt to engage, or disengage, the sheet material articles. The jaws positively grip the sheet material articles on the conveyor apparatus for allowing the articles to pass around the rollers without risk of the sheet material articles moving or slipping.

This invention relates, in one aspect, to a conveyor apparatus and more particularly to a conveyor apparatus for conveying sheet material articles and, in another aspect, to a manufacturing apparatus incorporating a conveyor.

It is well known to apply an adhesive to a sheet of paper or other covering material and to position the sheet onto a substrate, for example to obscure or conceal a region of the substrate, or to add function or to decorate the substrate. One application of this so-called method of lining is in the manufacture of board games, where a printed playing surface is adhered to a backing board. It will be appreciated that method can be used in a wide range of other laminating applications, including book-binding, printing and labelling.

The covers of hard-backed books are generally formed in a similar manner by laminating one or more boards of card or other substrate onto a pre-glued sheet of pliant covering material such as buckram, leather or fabric. The covering material is larger than the substrate, so that the edges of the covering material can be folded or wrapped over the edges of the substrate. A lining material may then be adhered to the uncovered side of the substrate as hereinbefore described. Menu cards, show cards, slip cases, game boards and other sheet material articles can be formed in a similar manner by placing one or more substrates onto the pre-glued sheet of covering material.

Each of the above-mentioned methods of laminating can be performed on a small scale by hand. However, it will appreciated that the process is both difficult and time consuming. Accordingly, laminating apparatus are known which are designed to make medium to long production runs. Such apparatus are generally complicated in construction and comprise numerous stations, the materials being transported between the stations by rollers and the like. Also, known apparatus do not readily lend themselves to short production runs or various sizes of boards.

WO9429206 discloses a laminating apparatus which attempts to overcome the above-mentioned problems and to satisfy the requirements of the low to medium volume end of the market, such as the increasingly popular bookbinding on demand market. The apparatus comprises a conveyor belt arranged to transport a sheet of covering material coated with an adhesive into the apparatus, and to halt when the sheet of covering material reaches a position where it is in face-to-face registration with boards to be covered. The boards are mounted to the underside of a frame disposed above the surface of the conveyor, which frame can be lowered to bring the boards into face-to-face contact with the sheet of covering material, thereby adhering the latter to the boards.

The conveyor belt runs around a vacuum chamber which serves to hold the sheet of covering material in-situ during transportation. However, this arrangement is complicated in construction and is unable to reliably hold the sheet material, particularly as the material passes around rollers at the end of the conveyor. The ability for the sheet material to pass around the end of the conveyor, before the board is laminated thereto, is particularly advantageous because it allows sensors to be used to determine the length of the sheet and its position on the conveyor, so that the user does not have to set the apparatus up each time the size or configuration of the sheets is changed.

I have now devised a conveyor apparatus which alleviates the above-mentioned problems.

In accordance with this invention, as seen from a first aspect, there is provided a conveyor apparatus comprising a belt mounted at opposite ends thereof to respective rollers, means attached to the belt for gripping an article to be conveyed, and means for actuating said gripping means at one or more selected rotary positions of the belt to engage or disengage said article, said gripping means comprising a displaceable jaw member to engage said article.

The gripping means positively grips articles on the conveyor, thereby allowing the articles to pass around the rollers without any risk of the articles moving or slipping.

Preferably the gripping means is elongate and extends perpendicular to the direction of movement of the conveyor.

In one embodiment, the gripping means comprises a plurality of jaw members disposed on a line which extends perpendicular to the belt, the members either being independently displaceable or interconnected, such that they are displaced together or in groups.

In an alternative embodiment the gripping means comprises an elongate jaw member extending perpendicular to the conveyor belt.

The belt may comprise a single wide belt member. Alternatively, it may comprise a plurality of narrower belt members mounted side-by-side on said rollers. In this embodiment, the gripping means may comprise an elongate base member which extends perpendicular to the direction of movement of the belt between the adjacent members thereof, the or each jaw member being mounted to the base.

Alternatively, a plurality of jaw members may be mounted to respective belt members at locations which are disposed on a line which extends perpendicular to the direction of movement of the belt.

At least one of said plurality of belt members may comprise a chain, for example driven by a sprocket.

Preferably the or each jaw member defines a mouth which is arranged to face rearwardly with respect to the direction of movement of the belt, such that the article being conveyed is gripped at its leading edge.

Preferably the or each jaw member is mounted to the belt for pivotal movement about an axis which extends perpendicular to the direction of movement of the belt.

Preferably the or each jaw member is biased into a normally closed position, in which the jaw grips the article.

In one embodiment, said actuating means is disposed outwardly of the belt and is displaceable inwardly towards the belt to actuate said gripping means.

In an alternative embodiment, said actuating means is disposed inside the belt and is displaceable outwardly through the conveyor to actuate the gripping means disposed on an external surface thereof.

In this embodiment, the actuating means may project through apertures formed in the conveyor or through gaps provided between adjacent sections of the conveyor.

Preferably said actuating means are arranged to cause said gripping means to disengage the article as the belt passes around a said roller, such that the article being conveyed can be ejected off the conveyor as the belt passes around said roller.

Preferably said actuating means is arranged to cause said gripping means to engage an article as the belt passes around the roller, such that an article can be fed onto the conveyor as the belt passes around the roller.

Preferably the foregoing is achieved by opening the or each jaw member as the gripping means approaches a roller on one run of the belt, and holding the or each jaw member open until the jaw member moves away from the aforementioned roller on the other run of the conveyor.

Preferably gripping means are disposed at a plurality of locations around the circumference of the belt.

Also in accordance with this invention, as seen from a second aspect, there is provided a manufacturing apparatus comprising a conveyor as hereinbefore defined.

Preferably means are provided for feeding a sheet material article onto the conveyor said gripping means being arranged to engage a leading edge of the sheet.

Preferably means are provided for feeding a second sheet material article onto the conveyor in face-to-face registration with said first-mentioned sheet material article.

Preferably a sensor is provided for determining the position of the first sheet material article on the conveyor. The sensor may comprise an optical sensor, preferably arranged to direct light between adjacent members of the belt.

Preferably means are provided for applying adhesive to said first-mentioned sheet material article prior to feeding the second sheet material article onto the conveyor.

Preferably the first-mentioned sheet material article is fed onto a first run of the conveyor, the second-mentioned sheet material article is fed onto the new run of the conveyor

An embodiment of this invention will now be described by way of an example only and with reference to the accompanying drawings, in which:

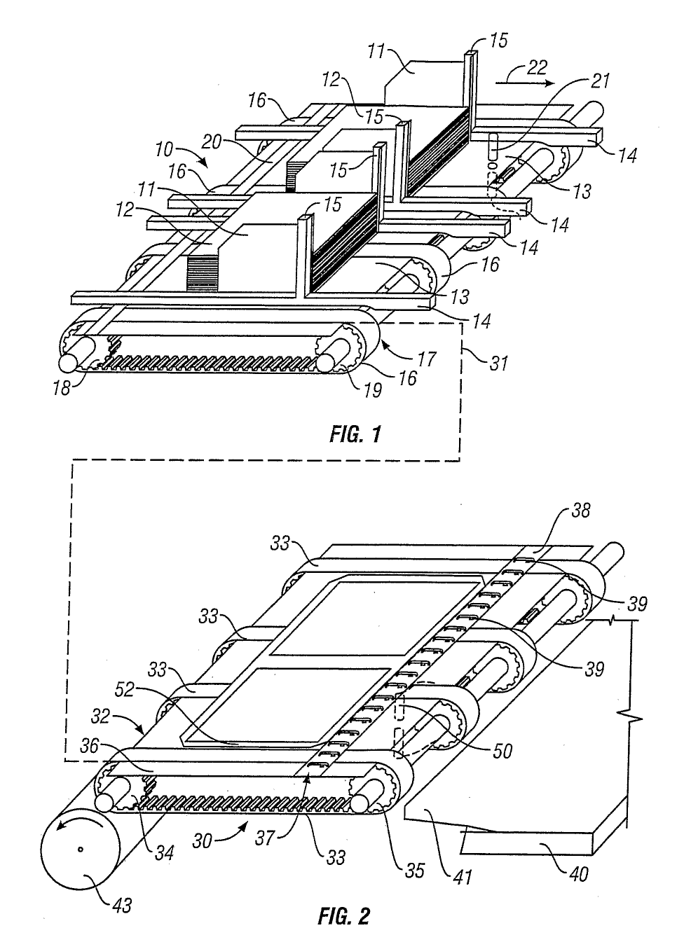

FIG. 1 is a perspective view of the feed portion of a casemaking apparatus in accordance with this invention;

FIG. 2 is a perspective view of an assembly portion of the apparatus of FIG. 1;

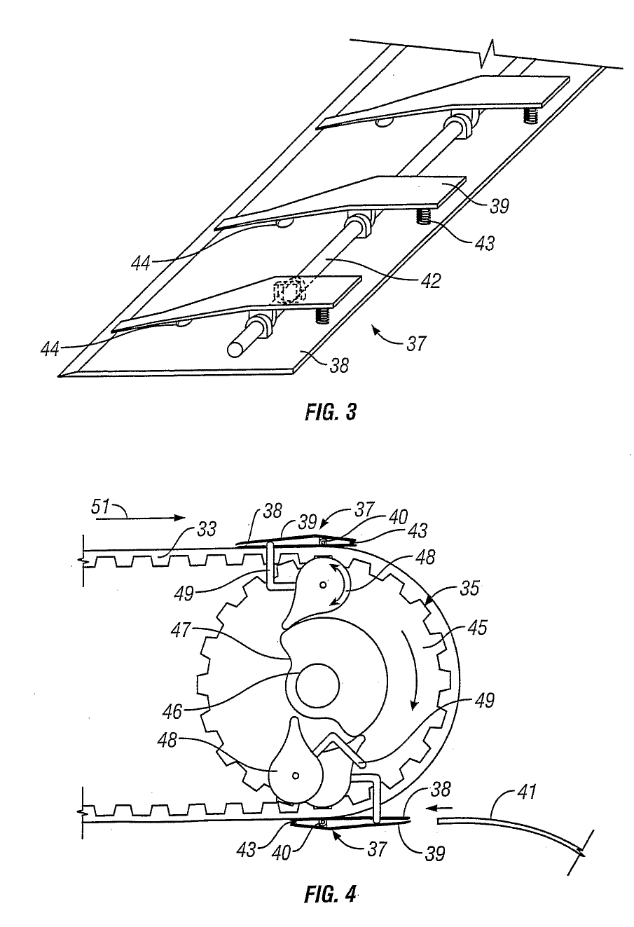

FIG. 3 is a perspective view of a gripper assembly of the apparatus of FIG. 1; and

FIG. 4 is a sectional view through a roller and belt of a conveyor of the assembly portion of the apparatus of FIG. 1.

Referring to FIG. 1 of the drawings, there is shown the feed portion 10 of a casemaking apparatus, which is arranged to cover or wrap one or more boards of a rigid substrate, such as card, with a covering material, such as paper.

The feed portion 10 comprises a plurality of hoppers 11 arranged to store a stack 12 of boards of card or other substrate material. The stacks 12 are supported on plates 13. The width of the hoppers 11 and the relative position thereof can be adjusted by moving respective pairs of the side bars of the hoppers laterally. The front edge of the stacks 12 are constrained by flanges, which extend longitudinally of upstanding uprights 15 on the side bars 14.

The feed portion 10 further comprises a horizontal conveyor 17 mounted on a pair of rollers 18, 19. The conveyor 17 comprises a plurality of side-by-side toothed belt members 16, each mounted on respective toothed wheels of the rollers 18, 19.

The plates 13 are disposed between the belt members 16 of the conveyor, such that they extend just above the plane of the upper run of the belt member 16. A thin strip 20 of metal extends across the conveyor, perpendicular to the direction of movement of the belt members 16. The strip 20 is attached to each of the belt members 16 and extends under the side bars 14 of the hoppers 11.

The rollers 18, 19 are driven by servo or stepper motors (not shown) to move the belt members 16 in the direction of the arrow 22. A photodetector 21 is directed through the conveyor 17 between adjacent belt members 16, at a position disposed in front of one of the stacks 12. The strip 20 is disposed behind the stacks 12.

In use, when the motors are energised, the strip 20 abuts the rear edge of the lower most sheets in the stack 12 and pushes the sheets forwardly in the direction of the arrow 22. The photodetector 21 senses the position of the leading edge of one of the sheets.

Referring to FIG. 2 of the drawings, there is shown an assembly portion 30 of the casemaking apparatus, which is mounted in front of the feed portion 10 of FIG. 1, as illustrated by the dotted line 31 connecting FIGS. 1 and 2. The assembly portion 30 includes a conveyor 32 in accordance with the present invention, which is mounted horizontally and comprises a plurality of spaced-apart toothed belt members 33 mounted side-by-side on rollers 34, 35, in a similar manner to the conveyor 16 of the feed portion of the apparatus of FIG. 1.

The upper run of the belt members 33 extend between respective portions of a horizontal plate 36. An elongate gripper assembly 37 extends across the conveyor 32, perpendicular to the direction of movement thereof. The gripper assembly 37 comprises an elongate strip-like base portion 38, which is fastened to each of the belt members 33. A plurality of gripper members 39 are mounted to the base portion 38 at respective locations along the length thereof.

A hopper 40 containing sheets 41 of covering material is mounted in front of the conveyor, slightly below the level of the bottom run thereof. A gluing roller 43 is mounted behind the conveyor 32 adjacent the roller 34.

Referring to FIG. 3 of the drawings, the gripper members 39 comprise elongate fingers which are pivoted intermediate their opposite ends to a shaft 42, which is axially mounted to the elongate base portion 38 of the gripper assembly 37. The leading end of the gripper members 39 are biased upwardly by respective springs 43. An aperture 44 is formed in the base portion 38 of the gripper assembly 37 under the trailing end of each gripper member 39.

Referring to FIG. 4 of the drawings, the roller 35 at the front end of the conveyor 32 comprises a plurality of toothed wheels 45 for driving the respective belt members 33, the wheels 45 being interconnected by an elongate axle 46, as shown in FIG. 2.

A lobed cam 47 is mounted around the axle 46 adjacent each wheel 45. The cam 47 and the axle 46 are fixed against rotation, the wheels 45 rotating around the axle 46.

A plurality of cam followers 48 are pivotally mounted to respective pins, which project axially from the side wall of each wheel, at a point disposed radially outwardly of the axle 46. The cam followers 48 comprise an elongated portion, the followers being rotationally biased, such that the elongated portions abut thereof the outer surface of the cam 47. The cam followers 48 each comprise radially-extending fingers 49.

When the rollers 34, 35 of the conveyor 32 are driven by stepper or servo motors (not shown) the cam followers 48 are caused to rotate about the cam 47, thereby causing the fingers 49 thereof to move radially inwardly and outwardly. The fingers 49 project up through the apertures 44 in the base portion 38 as the gripper assembly 37 approaches the roller 35 at the forward end of the conveyor. This causes the gripper members 39 to open against the spring bias. The lobe of the cam 47 is shaped such that the fingers 49 hold the gripper members 39 open as they travel around the roller 35, the fingers 49 being retracted as the gripper assembly 37 moves away from the roller 35 on the bottom run of the conveyor.

Referring to FIGS. 1 to 4 of the drawings, in use, the apparatus is energised to cause a sheet 41 of covering material to be fed from the hopper 40, such that the leading edge of the sheet 41 is engaged by the open gripper assembly 37 at the point where it leaves the roller 35 on the bottom run of the conveyor. The sheet 41 is thus carried along the bottom run of the conveyor, with the sheet depending from the conveyor under the influence of gravity. One face of the depending sheet 41 abuts the gluing roller 43 as the gripper assembly 38 moves around the roller 34 at the rear end of the conveyor. A photodetector 50 is directed through the underside of the belt so that the position of the gripper assembly 37 can be determined. The output of the two photodetectors 21, 50 are fed to a microprocessor (not shown), which controls the servo motors that drive the two conveyors 17, 32 as well as the feed mechanism of the hopper 40. The microprocessor is arranged to drive the conveyor 17 of the feed apparatus of FIG. 1 in such a manner that boards are fed from the stack 12 into face-to-face registration with the glued sheet 41 as it advances around the roller 34 onto the upper run of the conveyor 30. In this manner, two boards from the stacks 12 are placed in exact face-to-face registration on the glued sheet 41 to form a partially assembled case for a book as depicted at 52 in FIG. 2. The partially assembled case is then ejected from the conveyor for finishing by advancing it forwardly until the gripper assembly 37 releases the leading edge thereof as it approaches the roller 35.

A case making apparatus in accordance with this invention is relatively simple and inexpensive in construction, yet is able to reliably laminate a first sheet in precise registration with a second sheet. It will be appreciated that it is relatively straight forward to adjust the apparatus to handle sheets of different sizes and to form articles of different configurations.

It will also be appreciated that a conveyor in accordance with the present invention, as depicted in FIG. 2, has a wide range of applications in industries other than casemaking or laminating.

1-24. (canceled)

25. A conveyor apparatus, comprising:
a belt mounted at opposite ends thereof to respective rollers;
means for gripping an article to be conveyed attached to said belt; and,
means for actuating said means for gripping at one or more selected rotary positions of said belt for engaging, or disengaging, the article, said means for gripping including a displaceable jaw member for engaging the article.

26. The conveyor apparatus according to claim 25, wherein said means for gripping is elongate and extends perpendicularly to a direction of movement of said conveyor apparatus.

27. The conveyor apparatus according to claim 25, wherein said gripping means includes a plurality of jaw members disposed on a line extending perpendicularly to said belt, said jaw members either being independently displaceable or interconnected with one another.

28. The conveyor apparatus according to claim 25, wherein said gripping means includes an elongate jaw member extending perpendicular to said belt.

29. The conveyor apparatus according to claim 25, wherein said belt comprises a single wide belt member mounted on said rollers.

30. The conveyor apparatus according to claim 25, wherein said belt comprises a plurality of belt members mounted side-by-side on said rollers.

31. The conveyor apparatus according to claim 30, wherein said means for gripping comprises an elongate base member extending perpendicularly to a direction of movement of said belt between the adjacent said jaw members thereof, the, or each, said jaw member being mounted to said elongate base.

32. The conveyor apparatus according to claim 30, wherein said means for gripping comprises a plurality of jaw members mounted to respective said belt members at locations disposed on a line extending perpendicular to a direction of movement of the belt.

33. The conveyor apparatus according to claim 32, wherein at least one belt of a plurality of belt members comprises a chain.

34. The conveyor apparatus according to claim 25, wherein said jaw member defines a mouth facing rearwardly relative to a direction of movement of said belt, so that the article being conveyed is gripped at its leading edge.

35. The conveyor apparatus according to claim 25, wherein said jaw member is mounted to said belt for pivotal movement about an axis extending perpendicularly to a direction of movement of said belt.

36. The conveyor apparatus according to claim 25, wherein said jaw member is biased into a closed position wherein said jaw member grips the article.

37. The conveyor apparatus according to claim 25, wherein said means for actuating said means for gripping is disposed outwardly of said belt and displaceable inwardly towards said belt for actuating said means for gripping.

38. The conveyor apparatus according to claim 25, wherein said means for actuating said means for gripping is disposed inside said belt and displaceable outwardly through said conveyor apparatus for actuating said means for gripping disposed on an external surface thereof.

39. The conveyor apparatus according to claim 38, wherein said means for actuating said means for gripping projects through apertures formed in said belt or through gaps provided between adjacent sections of said belt.

40. The conveyor apparatus according to claim 25, wherein said means for actuating said means for gripping causes said means for gripping to disengage the article as said belt passes around a said roller, so that the article being conveyed is ejectable off said conveyor apparatus as said belt passes around said roller.

41. The conveyor apparatus according to claim 25, wherein said means for actuating said means for gripping causes said means for gripping to engage an article as said belt passes around one roller of said rollers, so that the article is able to be fed onto said conveyor apparatus as said belt passes around said roller.

42. The conveyor apparatus according to claim 25, wherein said means for gripping is disposed at a plurality of locations around the circumference of said belt.

43. A manufacturing apparatus, comprising:
a conveyor apparatus including:
a belt mounted at opposite ends thereof to respective rollers;
means for gripping an article to be conveyed attached to said belt; and,
means for actuating said means for gripping at one or more selected rotary positions of said belt for engaging, or disengaging, the article, said means for gripping including a displaceable jaw member for engaging the article.

44. The manufacturing apparatus according to claim 43, further comprising means for feeding a sheet material article onto said conveyor apparatus, said means for gripping being able to engage a leading edge of the sheet material article.
